(19) United States
(12) Patent Application Publication
(10) Pub. No.: US 2008/0036952 A1
(43) Pub. Date: Feb. 14, 2008

(54) Liquid crystal display device

(75) Inventors: Norihiro Yoshida, Kumagaya-shi (JP); Arihiro Takeda, Sagamihara-shi (JP); Jin Hirosawa, Saitama-shi (JP); Hiroyuki Kimura, Fukaya-shi (JP); Katsunori Ookochi, Fukaya-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: Toshiba Matsushita Display Technology Co., Ltd.

(21) Appl. No.: 11/889,163

(22) Filed: Aug. 9, 2007

(30) Foreign Application Priority Data
Aug. 10, 2006 (JP) 2006-218585

(51) Int. Cl. G02F 1/1335

(52) U.S. Cl. 349/113

(57) ABSTRACT

A liquid crystal display device includes an array substrate, a counter-substrate which is disposed to be opposed to the array substrate, with a gap being provided between the counter-substrate and the array substrate, a liquid crystal layer which is held between the array substrate and the counter-substrate and has liquid crystal with negative dielectric anisotropy, a pixel electrode which includes transparent electrodes and a reflective electrode which are formed on the same surface of the array substrate, a counter-electrode which is formed on the counter-substrate, and a transparent insulative element which is formed on the counter-electrode and controls alignment of the liquid crystal of the liquid crystal layer. The insulative element is disposed at a position opposed to the reflective electrode and covers an entire region of the reflective electrode.

### CROSS-REFERENCE TO RELATED APPLICATIONS

This application is based upon and claims the benefit of priority from prior Japanese Patent Application No. 2006-218585, filed Aug. 10, 2006, the entire contents of which are incorporated herein by reference.

### BACKGROUND OF THE INVENTION

1. Field of the Invention

The present invention relates generally to a liquid crystal display device, and more particularly to a transflective liquid crystal display device.

2. Description of the Related Art

According to display methods, liquid crystal display devices are generally classified into two categories, one being a reflective liquid crystal display device using ambient light, and the other being a transmissive liquid crystal display device using backlight. In addition, there is known a transflective liquid crystal display device which makes use of both the structures of the reflective liquid crystal display device and transmissive liquid crystal display device (see, e.g. Jpn. Pat. Appln. KOKAI Publication No. 2001-264750).

In the transflective liquid crystal display device, it is necessary to eliminate a phase difference between light components which pass through a liquid crystal layer in a transmissive display region and a liquid crystal layer in a reflective display region. In the prior art, as a method for eliminating the phase difference between the light components passing through the liquid crystal layer in the transmissive display region and the liquid crystal layer in the reflective display region, there has been proposed a multi-gap type transflective liquid crystal display device wherein the thickness of the liquid crystal layer is varied between the transmissive display region and reflective display region, thereby optimizing the thickness of the liquid crystal layer (see, e.g. Jpn. Pat. Appln. KOKAI Publication No. 2004-54129).

Also proposed is a method in which a decrease in contrast is prevented by making the thickness of the liquid crystal layer substantially equal between the reflective display region and the transmissive display region, without adopting the multi-gap system (see, e.g. Jpn. Pat. Appln. KOKAI Publication No. 2006-78742).

However, in a conventional normally-white transflective liquid crystal display device, the transmissive display region includes a stepped boundary part which is a boundary at which the thickness of the liquid crystal layer varies. In this case, if the stepped boundary part is positioned within the reflective display region, the thickness of the liquid crystal layer in the reflective display region becomes equal to the thickness of the liquid crystal layer in the transmissive display region on the transmissive display region side of the stepped boundary part in the reflective display region. As a result, a phase difference of light occurs in the reflective display region and, in some cases, abnormality occurs in color or gradation of reflective display.

In addition, in a transflective liquid crystal display device in which a liquid crystal is of a vertical alignment type, there is a case in which protrusions, or the like, for determining the direction of tilt of the liquid crystal are formed in order to achieve viewing-angle compensation. In the case where the pixel pitch is set at 50 μm or less, the transmittance may decrease, in some cases, if the ratio of the area of the protrusions formed in the opening part increases.

### BRIEF SUMMARY OF THE INVENTION

The present invention has been made in consideration of the above-described problems, and the object of the invention is to provide a liquid crystal display device which can effect display that is free of abnormality in color or gradation in a reflective display region in a transflective display device, with an excellent display quality, without decreasing transmittance at a time of transmissive display and reflective display.

In order to achieve the above object, according to an aspect of the invention, there is provided a liquid crystal display device comprising: an array substrate; a counter-substrate which is disposed to be opposed to the array substrate, with a gap being provided between the counter-substrate and the array substrate; a liquid crystal layer which is held between the array substrate and the counter-substrate and has liquid crystal with negative dielectric constant anisotropy; a pixel electrode which includes transparent electrodes and a reflective electrode which are formed on the same surface of the array substrate; a counter-electrode which is formed on the counter-substrate; and a transparent insulative element which is formed on the counter-electrode and controls alignment of a liquid crystal of the liquid crystal layer, wherein the insulative element is disposed at a position opposed to the reflective electrode and covers an entire region of the reflective electrode.

The present invention can provide a liquid crystal display device which can effect display that is free of abnormality in color or gradation in a reflective display region in a transflective display device, with an excellent display quality, without decreasing transmittance at a time of transmissive display and reflective display.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a perspective view showing an example of a liquid crystal display device according to an embodiment of the present invention;

FIG. 2 is a view for describing an example of the structure of the liquid crystal display device shown in FIG. 1;

FIG. 3 is a cross-sectional view for describing an example of the structure of a liquid crystal display panel of the liquid crystal display device shown in FIG. 1;

FIG. 4 is a cross-sectional view for describing an example of the structure of an array substrate of the liquid crystal display device shown in FIG. 1;

FIG. 5A is a plan view for describing an example of the structure of a display pixel of the array substrate according to Example 1 of the present invention;

FIG. 5B is a cross-sectional view for describing the example of the structure of the display pixel of the array substrate according to Example 1 of the invention;

FIG. 6A is a plan view for describing an example of the structure of a display pixel of an array substrate according to Comparative Example 1;

FIG. 6B is a cross-sectional view for describing the example of the structure of the display pixel of the array substrate according to Comparative Example 1;

FIG. 7A is a plan view for describing an example of the structure of a display pixel of an array substrate according to Comparative Example 2;

FIG. 7B is a cross-sectional view for describing the example of the structure of the display pixel of the array substrate according to Comparative Example 2;

FIG. 8 is a table showing an example of an evaluation result which was obtained by observing displays in Example 1, Comparative Example 1 and Comparative Example 2;

FIG. 9 is a view for describing an example of the arrangement of protrusions on a counter-substrate in the liquid crystal display device according to Example 1 of the invention; and

FIG. 10 is a view for describing another example of the arrangement of protrusions on the counter-substrate.

### DETAILED DESCRIPTION OF THE INVENTION

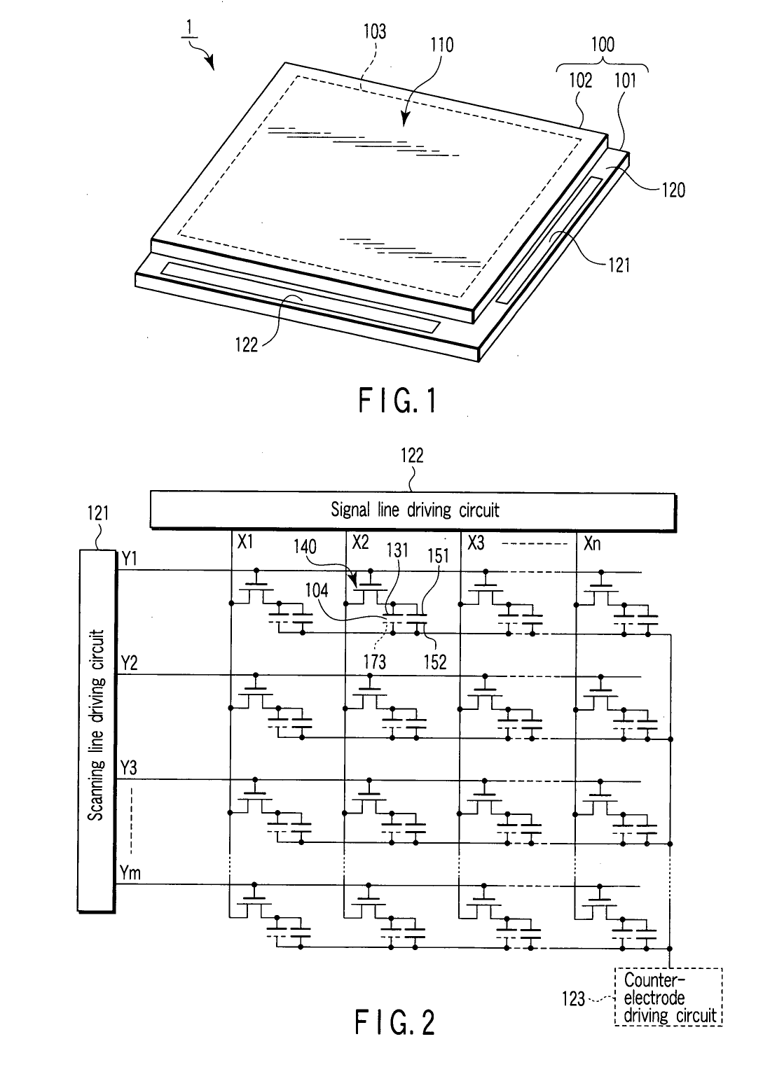

An embodiment of a liquid crystal display device according to the present invention will now be described with reference to the accompanying drawings. As shown in FIG. 1, a liquid crystal display device 1 according to the embodiment includes a liquid crystal display panel 100. The liquid crystal display panel 100 includes an array substrate 101, a counter-substrate 102 which is opposed to the array substrate 101 and attached to the array substrate 101 via an outer edge seal member 103, and a liquid crystal layer 104 which is formed between these substrates.

The liquid crystal display panel 100 includes a display area 110 which is composed of a plurality of display pixels PX that are arrayed in a matrix, and a peripheral area 120 surrounding the display area 110. As shown in FIG. 1, the display area 110 is formed within a region surrounded by the outer edge seal member 103, and the peripheral area 120 is disposed along the outer periphery of this region.

As shown in FIG. 2, a plurality of signal lines X1 to Xn and a plurality of scanning lines Y1 to Ym are disposed to cross each other in the display area 110. In the peripheral area 120 shown in FIG. 1, the array substrate 101 includes a scanning line driving circuit 121 which drives the scanning lines Y1 to Ym, and a signal line driving circuit 122 which drives the signal lines X1 to Xn.

In the display area 110, the array substrate 101 includes an (m×n) number of pixel electrodes 131 which are disposed in a matrix in the respective display pixels PX. On the other hand, the counter-electrode 102 includes a counter-electrode 173 which is opposed to all the pixel electrodes 131, with the liquid crystal layer 104 being interposed.

A liquid crystal 106 that is used in the liquid crystal layer 104 has liquid crystal with negative dielectric constant anisotropy. The liquid crystal 106 is aligned substantially perpendicular to the array substrate 101 or counter-substrate 102 in the state in which no voltage is applied between the pixel electrodes 131 and counter-electrode 173 or in the state in which a voltage less than a threshold value is applied between the pixel electrodes 131 and counter-electrode 173.

On the other hand, in the state in which a voltage of the threshold value or more is applied between the pixel electrodes 131 and counter-electrode 173, the liquid crystal 106 is aligned to be inclined or substantially parallel to the array substrate 101 or counter-substrate 102. At this time, the liquid crystal 106 has such properties that the direction of inclination of the liquid crystal 106 is approximately determined by the direction of electric flux lines 105.

In addition, the array substrate 101 includes an (m×n) number of thin-film transistors (TFTs) which are disposed as switching elements 140 near intersections between the scanning lines Y and signal lines X in association with the (m×n) number of pixel electrodes 131.

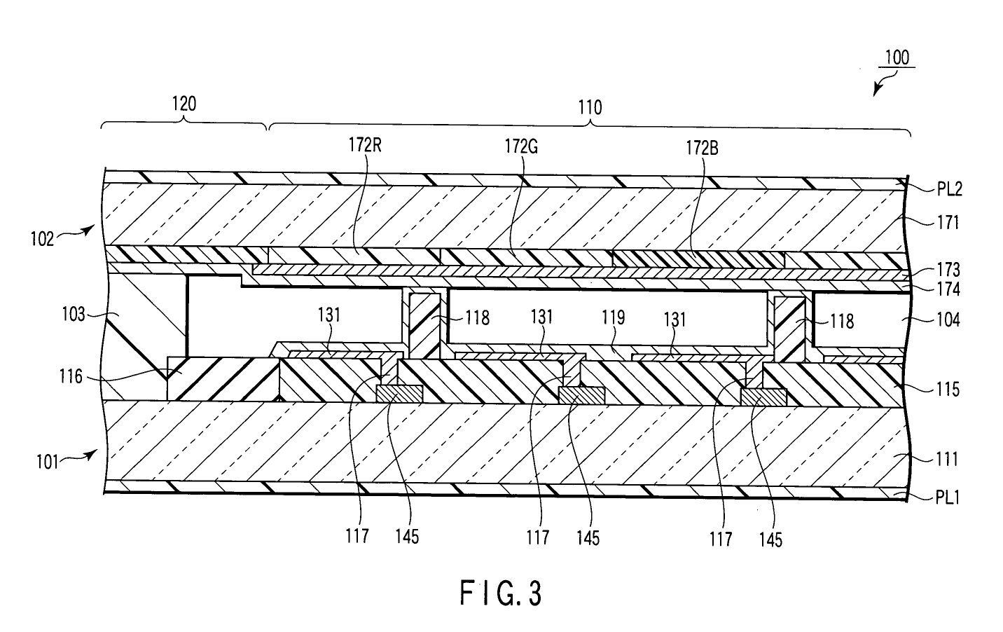

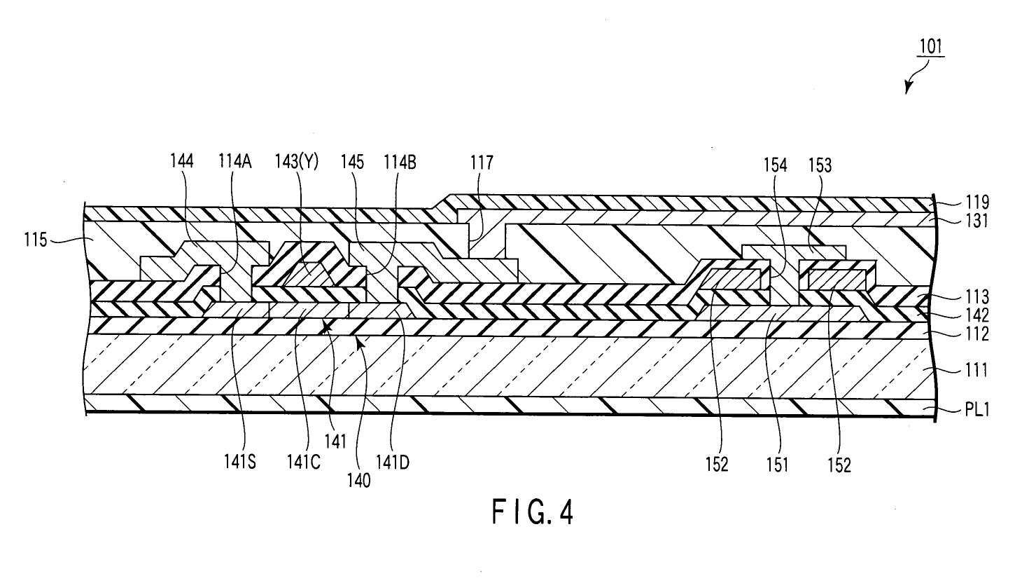

FIG. 3 is a cross-sectional view of the liquid crystal display panel 100 at a region near the boundary between the peripheral area 120 and display area 110. FIG. 4 is a cross-sectional view of the array substrate 101 at a region near an intersection between the scanning line Y and signal line X shown in FIG. 2. The structural parts shown in FIG. 3 and FIG. 4 will be described below.

A source electrode 144 of the switching element 140 is connected to the associated signal line X (or formed integral with the signal line X). A gate electrode 143 of the switching element 140 is connected to the associated scanning line Y (or formed integral with the scanning line Y). A drain electrode 145 of the switching element 140 is connected to the pixel electrode 131 (or formed integral with the pixel electrode 131).

The array substrate 101 includes a storage capacitance electrode 151 at a position of each pixel electrode 131 so that the potential of the storage capacitance electrode 151 is set to be equal to that of the pixel electrode 131. The array substrate 101 further includes a storage capacitance line 152 which is connected to each storage capacitance electrode 151, and a counter-electrode driving circuit 123 which is connected to each storage capacitance line 152 and the counter-electrode 173. The counter-electrode driving circuit 123 controls the potentials of each storage capacitance line 152 and counter-electrode 173 at a predetermined value. The storage capacitance is constituted by each storage capacitance electrode 151 and the storage capacitance line 152 connected to the associated storage capacitance electrode 151.

As shown in FIG. 3 and FIG. 4, the array substrate 101 includes a transparent insulative substrate 111 such as a glass substrate, and also includes a polarizer plate PL1 which is attached to the back side of the insulative substrate 111. In the display area 110, an undercoat layer 112 is disposed on the insulative substrate 111. The switching element 140 is provided on the undercoat layer 112.

In the switching element 140, a semiconductor layer 141 that is formed of a polysilicon film is disposed on the undercoat layer 112. The semiconductor layer 141 includes a channel region 141C, and a source region 141S and a drain region 141D which are doped with impurities and are formed on both sides of the channel region 141C. The storage capacitance electrode 151, which is formed of an impurity-doped polysilicon film, is disposed on the undercoat layer 112.

A gate insulation film 142 is formed on the undercoat layer 112, semiconductor layer 141 and storage capacitance electrode 151. The gate electrode 143, the scanning line Y that is integral with the gate electrode 143, and the storage capacitance line 152 are formed on the gate insulation film 142. A part of the storage capacitance line 152 is opposed to the storage capacitance electrode 151. The storage capacitance line 152 is formed of the same material as the scanning line Y and extends substantially in parallel to the scanning line Y.

An interlayer insulation film 113 is disposed on the gate insulation film 142, gate electrode 143, scanning line Y and storage capacitance line 152. The source electrode 144, signal line X, drain electrode 145 and a contact electrode 153 are disposed on the interlayer insulation film 113.

The signal line X is disposed to extend substantially perpendicular to the scanning line X and storage capacitance line 152. In addition, the signal line X, scanning line Y and storage capacitance line 152 are formed of a light-blocking low-resistance material.

For example, the scanning line Y and storage capacitance line 152 are formed of molybdenum-tungsten, and the signal line X, in many cases, is formed of aluminum. The source electrode 144 and drain electrode 145, which are formed of, e.g. aluminum, are connected to the source region 141S and drain region 141D via contact holes 114A and 114B which penetrate the gate insulation film 142 and interlayer insulation film 113.

The contact electrode 153 is connected to the storage capacitance electrode 151 via a contact hole 154 which penetrates the gate insulation film 142 and interlayer insulation film 113. The contact electrode 153 is formed of the same material as the signal line X and is connected to the signal line X. Accordingly, the drain electrode 145, pixel electrode 131 and storage capacitance electrode 151 have the same potential.

In the display region 110, a transparent resin layer 115 is disposed on the interlayer insulation film 113, source electrode 144, drain electrode 145, scanning line X, signal line Y and contact electrode 153. A light-blocking layer 116 is further disposed in the peripheral area 120.

The pixel electrode 131, which is formed of a light-transmissive electrically conductive material such as ITO (Indium Tin Oxide), is disposed on the transparent resin layer 115. The pixel electrode 131 is connected to the drain electrode 145 of the switching element 140 via a through-hole 117 that penetrates the transparent resin layer 115. Further, columnar spacers 118, each having a height of 2.0 μm, are disposed on the transparent resin layer 115.

An alignment film 119 is disposed on the transparent resin layer 115 and pixel electrodes 131 so as to cover the columnar spacers 118. The alignment film 119 functions to align the liquid crystal 106, which is included in the liquid crystal layer 104, in a direction substantially perpendicular to the substrate surface of the array substrate 101.

On the other hand, the counter-substrate 102 includes a transparent insulative substrate 171 such as a glass substrate, and a polarizer plate PL2 is attached to the front side of the insulative substrate 171. In the display area 110, the counter-substrate 102 includes a red color filter layer 172R, a green color filter layer 172G and a blue color filter layer 172B, which are disposed on the insulative substrate 171. The counter-electrode 173 is disposed on the color filters so that the counter-electrode 173 may be opposed to all the pixel electrodes 131.

The counter-electrode 173 is formed of a light-transmissive electrically conductive material such as ITO. An alignment film 174 is disposed on the counter-electrode 173. The alignment film 174 functions to align the liquid crystal 106 of the liquid crystal layer 104 in a direction substantially perpendicular to the substrate surface of the counter-substrate 102. The array substrate 101 and counter-substrate 102 are attached to each other via the outer edge seal member 103. An example of the above-described liquid crystal display device according to the invention will be described below.

### EXAMPLE 1

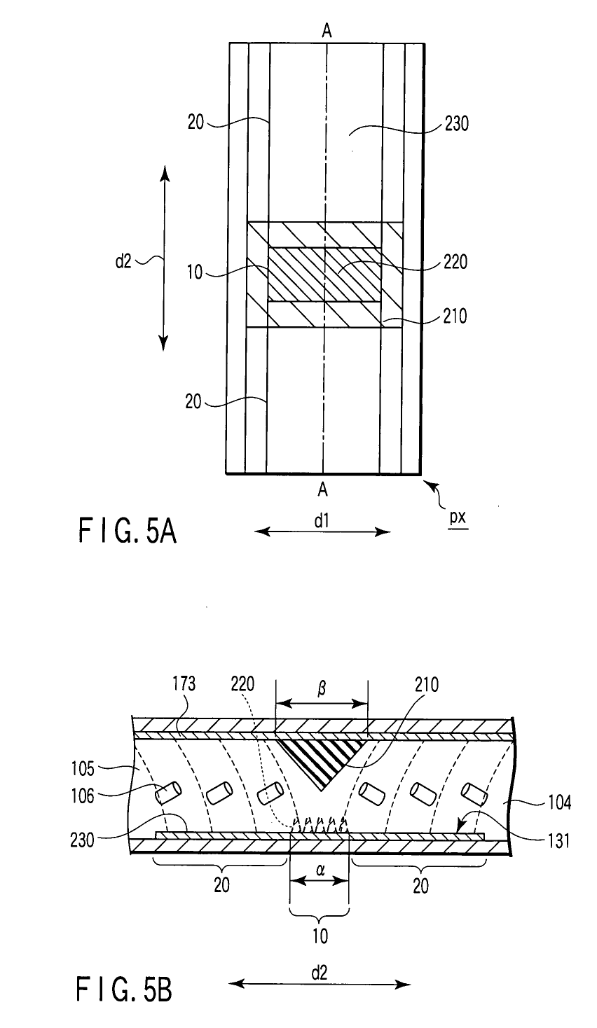

Example 1 of the liquid crystal display device 1 is described. FIG. 5A and FIG. 5B show an example of the structure of the display pixel of the array substrate according to Example 1. As shown in FIG. 5A and FIG. 5B, the liquid crystal display device 1 according to Example 1 is a transflective liquid crystal display device. Specifically, a liquid crystal display panel 100 of the liquid crystal display device 1 of Example 1 is configured such that each of display pixels PX includes transmissive display regions 20 and a reflective display region 10.

FIG. 5A is a plan view that schematically shows the display pixel PX when the liquid crystal display panel 100 is viewed from the counter-substrate 102 side.

The reflective display region 10 is a region where ambient light is reflected by a reflective electrode 220. The transmissive display region 20 is a region where the reflective electrode 220 is not provided and only a transmissive electrode 230, which passes light from a backlight (not shown), is disposed. In Example 1, the reflective display region 10 is disposed between the transmissive display regions 20 at a position where the display pixel PX is substantially halved in a direction d2 that is parallel to the long side of the display pixel PX.

The pixel electrode 131 is provided on the array substrate 101, as described above. In Example 1, the pixel electrode 131 is composed of the transmissive electrode 230 that is formed of ITO, which is a light-transmissive electrically conductive material, and the reflective electrode 220 that is formed of aluminum. The transmissive electrode 230 and reflective electrode 220 are disposed on the same surface of the array substrate 101.

In Example 1, the transmissive electrode 230 is disposed in each display pixel PX. The reflective electrode 220 is disposed on a central portion of the display pixel PX in the direction d2 that is parallel to the long side of the display pixel PX.

Specifically, as shown in FIG. 5A, when the display pixel PX is viewed from the counter-substrate 102 side, the reflective electrode 220 is disposed on the central portion of the display pixel PX in the direction d2, and the transmissive electrodes 230 are disposed on both sides of the reflective electrode 220 in the direction d2.

In Example 1, an insulative protrusion 210, which is formed of a transparent resin, is disposed on the counter-electrode 173 of the counter-substrate 102. Specifically, the protrusion 210 is disposed between the counter-electrode 173 and alignment film 174.

The protrusion 210 is disposed so as to be opposed to the reflective electrode 220 provided on the array substrate 101. Specifically, when the liquid crystal display panel 100 is viewed from the counter-substrate 102 side, the protrusion 210 is disposed so as to cover the entirety of the reflective electrode 220.

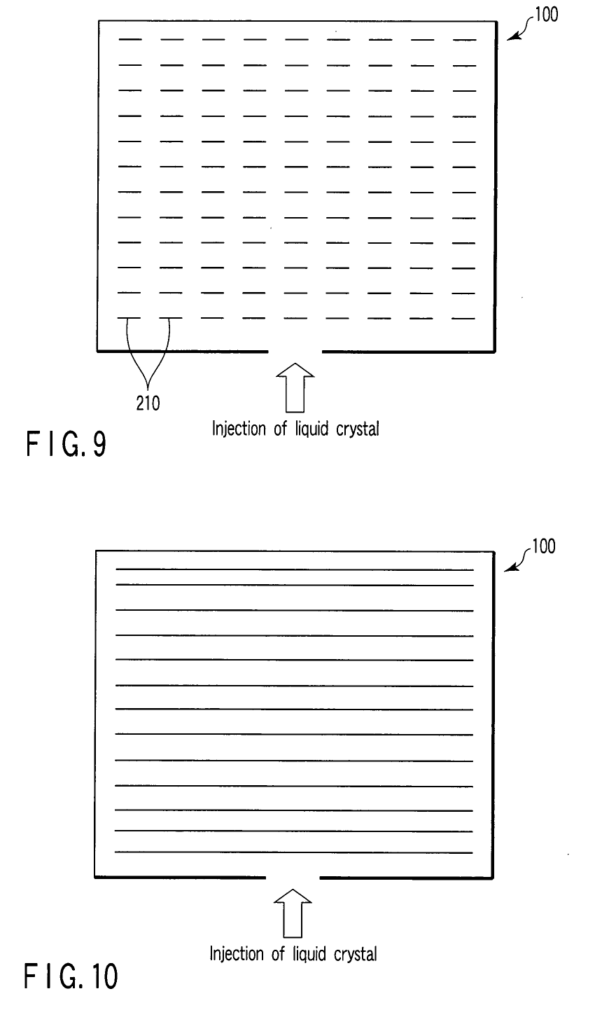

In the display pixel PX, the protrusion 210 is provided in the reflective display region 10 at a position where the pixel that is composed of the reflective display region 10 and transmissive display regions 20 is halved in the direction d2. In addition, as shown in FIG. 5A, the protrusion 210 extends in a direction d1 that is parallel to the short side of the display pixel PX, and is disposed in each display pixel PX, as shown in FIG. 9.

When a voltage is applied to the pixel electrodes 131 and counter-electrode 173, an electric field occurs in the liquid crystal layer 104, and electric flux lines 105 are generated, as shown in FIG. 5B. Since there is a part in which the counter-electrode 173 is covered with the insulative protrusion 210, the electric flux lines 105 are inclined toward the direction d2, with the protrusion 210 being the boundary. Since the liquid crystal 106 has such properties that the direction of the liquid crystal 106 is determined by the direction of inclination of electric flux lines 105, the major axis of the liquid crystal 106 is inclined toward the protrusion 210.

To be more specific, in the display pixel PX, two regions, where the liquid crystal 106 included in the liquid crystal layer 104 is aligned substantially in the same direction, are formed by the protrusion 210.

In FIG. 5B, α is the width of the reflective electrode 220 in the direction d2, and β is the width of the protrusion 210 in the direction d2. In Example 1, α was set at 20 μm, and β was set at 25 μm. The alignment film 119, 174 was coated with a thickness of 100 μm, and the pitch of display pixels PX in the direction d1 (i.e. the interval between the centers of display pixels PX in the direction d1) was set at 30 μm.

In Example 1, as shown in FIG. 5A, the area of the region where the reflective electrode 220 is disposed within each display pixel PX is less than the area of the region where the protrusion 210 is disposed. The reason for this is explained below.

As shown in FIG. 5A, in Example 1, the region where the reflective electrode 220 is disposed and the region where the protrusion 210 is disposed are arranged to be opposed to each other in the reflective display region 10. Thereby, when a voltage is applied to the liquid crystal layer 104, the protrusion 210 functions to determine the alignment state of the liquid crystal 106.

In the region where the protrusion 210 is present, since the voltage that is applied to the liquid crystal layer 104 is decreased by the insulative protrusion 210, the phase of light changes in the liquid crystal layer 104. As a result, the protrusion 210 also functions to make the phase of light in the liquid crystal layer 104 equal between the reflective display region 10 and the transmissive display region 20.

Accordingly, in Example 1, there is no difference in phase of light between the reflective display region 10 and the transmissive display region 20, and it is possible to prevent abnormality in color or gradation in the transmissive display and reflective display.

The display of the liquid crystal display device according to the above-described Example 1 was observed, and it was found that the display quality was good both in reflective display and transmissive display.

### COMPARATIVE EXAMPLE 1

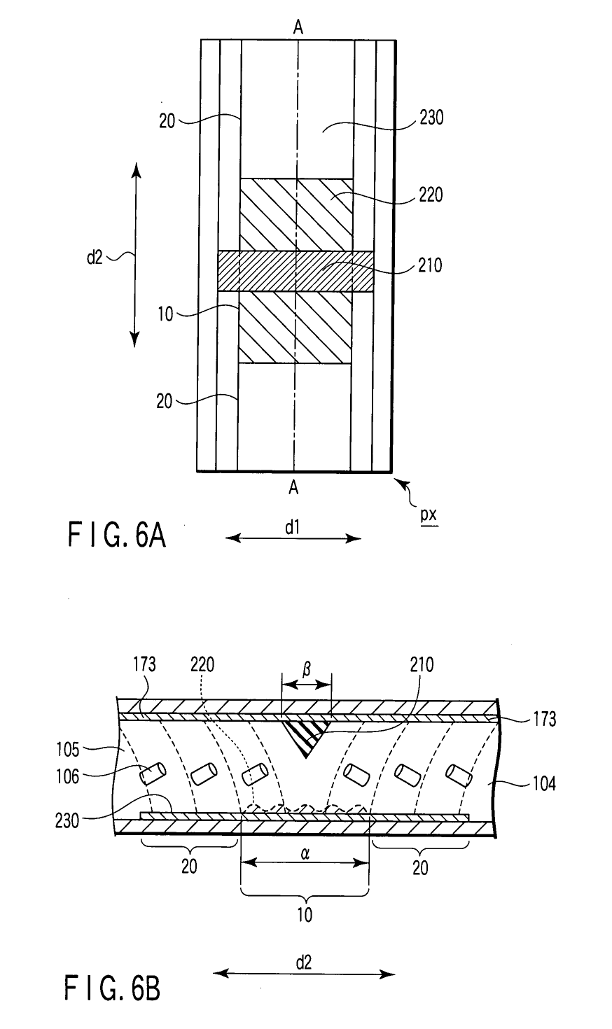

Next, a description is given of a liquid crystal display device according to Comparative Example 1 for comparison with the liquid crystal display device 1 of Example 1 of the invention. FIG. 6A is a plan view of the display pixel PX as viewed from the counter-substrate 102 side. Comparative Example 1 differs from Example 1 in that the protrusion 210, which is formed of an insulative transparent resin on the counter-substrate 102, covers only a part of the reflective electrode 220 disposed on the array substrate 101.

Specifically, as shown in FIG. 6A, in Comparative Example 1, the region where the reflective electrode 220 is disposed in the display pixel PX is greater than the region where the protrusion 210 is disposed. In the other structural aspects, Comparative Example 1 is the same as Example 1.

FIG. 6B is a schematic cross-sectional view taken along line A-A in FIG. 6A. In the direction d2, the width α of the reflective electrode 220 is 20 μm, and the width β of the protrusion 210 is 10 μm. The other conditions for fabrication are the same as those of the liquid crystal display device 1 of Example 1.

The display of the liquid crystal display device according to Comparative Example 1 was observed, and it was found that there was no problem at the time of transmissive display but gray-level inversion occurred at the time of reflective display.

### COMPARATIVE EXAMPLE 2

Next, a description is given of a liquid crystal display device according to Comparative Example 2 for comparison with the liquid crystal display device 1 of Example 1 of the invention.

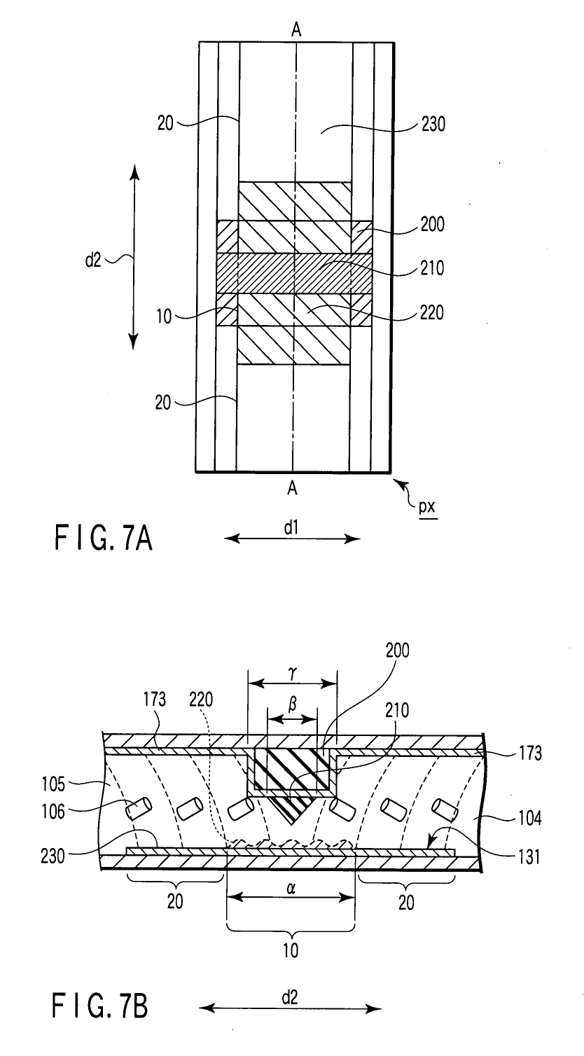

Comparative Example 2 differs from Example 1 in that an insulative transparent resin layer 200 covers only a part of the reflective electrode 220 provided on the array substrate 101. Specifically, as shown in FIG. 7A, in Comparative Example 2, the region where the reflective electrode 220 is disposed in the display pixel PX is greater than the region where the transparent resin layer 200 is disposed.

FIG. 7B is a simplified cross-sectional view taken along line A-A in FIG. 7A. Referring to FIG. 7B, the relationship in stacking of components on the counter-substrate 102 is described. The transparent resin layer 200 is provided under the counter-substrate 102, and the counter-electrode 173 is provided under the transparent resin layer 200. The protrusion 210 is provided under the counter-electrode 173, and the alignment film 174 is provided under the protrusion 210.

In the direction d2 in FIG. 7A, the width α of the reflective electrode 220 is 30 μm, the width γ of the transparent resin layer 200 is 20 μm, and the width β of the protrusion 210 is 10 μm. The other conditions for fabrication of the liquid crystal display device are the same as those in Example 1 and Comparative Example 1.

The display of the liquid crystal display device according to Comparative Example 2 was observed, and it was found that there was no problem at the time of transmissive display but gray-level inversion occurred at the time of reflective display.

The display results of Example 1 and Comparative Example 1 will now be discussed. If the area occupied by the protrusion 210 in the display pixel PX is increased as in Example 1, compared to Comparative Example 1, the area of the protrusion 210, which makes the passage of backlight difficult, increases, compared to Comparative Example 1. It is thus considered that the transmittance of transmissive display would greatly decrease.

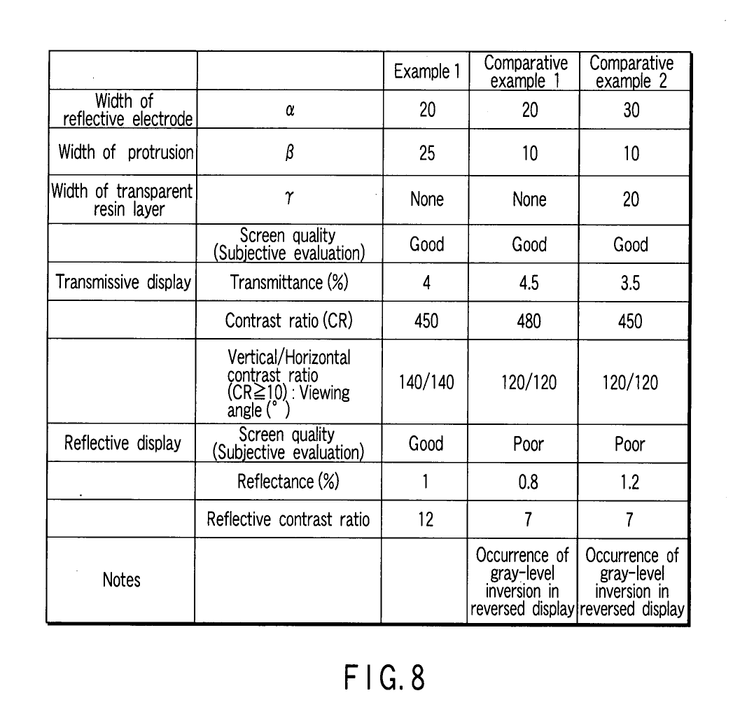

In fact, however, as shown in FIG. 8, the decrease in transmittance in Example 1, compared to Comparative Example 1, is only about 11%. In addition, a decrease in contact ratio (CR), which is obtained by dividing the transmittance of light for white display by the transmittance of light for black display, is about 6% in transmissive display and is very small. Thus, there is no problem.

In usual cases, in the liquid crystal display device in which the liquid crystal 106 is of the vertical alignment type as in the embodiment of the invention, a viewing-angle compensation plate is used so that the viewing-angle characteristics may become better as the transmittance becomes lower. Thus, because of the presence of the part with a low transmittance, the viewing angle in the vertical/horizontal directions is improved by 20° in Example 1, compared to Comparative Example 1.

On the other hand, in the case of reflective display, the reflectance in Example 1 increases by 25%, compared to Comparative Example 1. In addition, the contrast ratio (CR) in reflective display increases by 72%. It is thus understood that the structure of Example 1 is very advantageous.

Moreover, in Comparative Example 1, there is the problem that gray-level inversion occurs in reflective display. In Example 1, however, no gray-level inversion occurs in reflective display, and the problem of abnormality in color and gradation in reflective display can be avoided. As has been described in connection Example 1, it is demonstrated that the protrusion 20 has such advantages that the voltage that affects the liquid crystal layer 104 is decreased and the phase change of light passing through the liquid crystal layer 104 is optimized.

Accordingly, since the above-described advantages are obtained if the protrusion 210 covers the reflective electrode 220 in the reflective display region 10, it should suffice if the following condition is satisfied:

0<α≦β (1)

where α is the width of the reflective electrode, and β is the width of the protrusion 210.

Next, the display results of Example 1 and Comparative Example 2 are discussed. It is understood that in the transmissive display, the transmittance is lower in Comparative Example 2 than in Example 1 because of the presence of the transparent resin layer 200.

In addition, in Comparative Example 2, at the stepped part of the transparent resin layer 200, the alignment of the liquid crystal 106 is disturbed, and leakage of light occurs. On the other hand, in Example 1, there is no stepped part, such as the stepped part of the transparent resin layer 200. Thus, the alignment of the liquid crystal 106 is not disturbed, and no leakage of light occurs.

The reflective contrast ratio is a value that is calculated by dividing the transmittance of light for white display by the transmittance of light for black display. In Example 1, compared to Comparative Example 2, the transmittance of light at the time of black display is low, and accordingly the reflective contract ratio is high.

Taking the results of FIG. 8 into account, if the condition of the above-described formula (I) is satisfied, sufficiently good transmissive display and reflective display can be obtained with the structure of the protrusion 210 as in Example 1 of the invention.

The above-described embodiment of the present invention can provide a liquid crystal display device which can effect display that is free of abnormality in color or gradation in reflective display in a transflective display device, with an excellent display quality, without decreasing transmittance at a time of transmissive display and reflective display.

As shown in FIG. 9, protrusions 210 in the embodiment of the invention are independently disposed in the respective display pixels. With this disposition, compared to the case in which protrusions 210 are continuously disposed along rows of display pixels PX, for example, as shown in FIG. 10, the injection of liquid crystal is made easier, the time needed for fabricating the liquid crystal display device can be shortened, and the manufacturing yield can be improved.

In the above-described embodiment, the protrusion 210 is opposed to the reflective electrode 220 in the reflective display region 10, and the reflective display region 10 is disposed between the transmissive display regions 20. Accordingly, the liquid crystal 106 is aligned in two directions, with the protrusion 210 being the boundary. Thus, with the above-described disposition of the protrusion 210, the viewing-angle characteristics can be compensated, and the quality of transmissive display and reflective display can be improved.

The present invention is not limited directly to the above-described embodiments. In practice, the structural elements can be modified without departing from the spirit of the invention. For example, in the liquid crystal display device according to the embodiment, the pitch of display pixels in the short-side direction d1 is about 30 μm, but the value of the pitch is not limited to this example. Specifically, the invention is more effectively applicable to a liquid crystal display device in which the pitch of display pixels PX in the direction d1 is about 50 μm or less.

In the case where the pitch of display pixels PX in the short-side direction d1 is about 50 μm or less, the protrusion 210 may be disposed at the position where the pixel electrode 131 is halved in the direction d2 as in the above-described Example 1. Thereby, the electric flux lines 105 can be inclined over the entire pixel electrode, and thus domain segmentation can stably be effected in the liquid crystal 106, the alignment of which is determined by the electric flux lines 105.

In the above-described liquid crystal display device, the display pixel has a rectangular shape, but it may have a square shape. In this case, too, the same advantageous effects can be obtained by satisfying the condition of the formula (I).

Various inventions can be made by properly combining the structural elements disclosed in the embodiments. For example, some structural elements may be omitted from all the structural elements disclosed in the embodiments. Furthermore, structural elements in different embodiments may properly be combined.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A liquid crystal display device comprising:
an array substrate;
a counter-substrate which is disposed to be opposed to the array substrate, with a gap being provided between the counter-substrate and the array substrate;
a liquid crystal layer which is held between the array substrate and the counter-substrate and has liquid crystal with negative dielectric anisotropy;
a pixel electrode which includes transparent electrodes and a reflective electrode which are formed on the same surface of the array substrate;
a counter-electrode which is formed on the counter-substrate; and
a transparent insulative element which is formed on the counter-electrode and controls alignment of the liquid crystal of the liquid crystal layer,
wherein the insulative element is disposed at a position opposed to the reflective electrode and covers an entire region of the reflective electrode.

2. The liquid crystal display device according to claim 1, wherein in the pixel electrode, the reflective electrode is provided between the transmissive electrodes.

3. The liquid crystal display device according to claim 1 or 2, wherein the insulative element is disposed at a position where the pixel electrode is substantially halved.

4. The liquid crystal display device according to any one of claims 1 to 2, wherein the pixel electrode has a substantially rectangular shape, and the insulative element extends substantially in parallel to a short side of the pixel electrode.

5. The liquid crystal display device according to any one of claims 1 to 2, wherein the pixel electrode has a substantially rectangular shape, and a relationship, 0<α≦β, is satisfied, where α is a width of the reflective electrode in a long-side direction of the pixel electrode, and β is a width of the insulative element in the long-side direction of the pixel electrode.
